(19) United States
(12) Patent Application Publication
(10) Pub. No.: US 2007/0232399 A1
(43) Pub. Date: Oct. 4, 2007

(54) Mobile trading card generation and distribution

(76) Inventors: Brian F. Kathman, Alexandria, VA (US); Kenneth A. Jones, Newburyport, MA (US); Peter C. Fuller, Mountain View, CA (US)

Correspondence Address: ROBERT PLOTKIN, PC, 45 BUTTERNUT CIRCLE, CONCORD, MA, 01742-1937, US

(21) Appl. No.: 11/396,887

(22) Filed: Apr. 3, 2006

(51) Int. Cl. A63F 13/00

(52) U.S. Cl. 463/42

(57) ABSTRACT

A computer-implemented method for generating and distributing electronic trading cards, such as for use with mobile devices, generates instances of electronic trading cards and distributes the instances to users over a computer network. A finite number of instances of each electronic trading card may be generated. Electronic trading card instances may include an image and a digital watermark. Each instance of an electronic trading card may have a unique identifier. One instance of an electronic trading card may include content that is not included on all other instances of the same card. A randomly-generated “pack” of cards may be purchased by and distributed to the user. The contents of the pack may not be made visible to the user until completion of the purchase. Users may purchase additional features, such as a guarantee that the user will not be provided with duplicate instances of any trading card.

### CROSS REFERENCE TO RELATED APPLICATIONS

This application is related to a commonly-owned and concurrently-filed application entitled “Mobile Trading Card Redemption,” which is hereby incorporated by reference herein.

### BACKGROUND

1. Field of the Invention

The present invention relates to generation and distribution of digital content and, more particularly, to generation and distribution of electronic trading cards for use with mobile devices.

2. Related Art

Trading cards, including baseball cards and cards related to movies and other events, remain popular among people of all ages, decades after they were first introduced. Most trading cards are still generated and distributed in the same manner as in the early twentieth century. Consider baseball cards, for example. Before the beginning of a new baseball season, a baseball card manufacturer gathers information about sports teams and individual players from the previous season. Such information includes both statistics and photographs of the players. The manufacturer then designs a card for each player. Typically, the front of the card includes a photograph of the player and the name and/or logo of the player's team, while the back of the card includes statistics related to the player, such as the player's batting average.

The manufacturer compiles a “set” of such cards, which may also include certain special cards, such as cards representing entire teams or most-valuable players (MVPs). The set typically includes a finite number of cards (e.g., 800), each of which is numbered. The manufacturer then uses conventional printing presses to print large runs of the sets of cards. Some cards may be printed in different quantities than others. For example, the manufacturer may print only a small number of copies of a card representing an MVP, while the manufacturer may print a large number of copies of a card representing an average player. The result is a finite number of copies of each card in the set for the upcoming season.

The manufacturer sells and distributes the cards primarily in one of two ways. First, the manufacturer may generate packs of cards, each of which contains a small number (e.g., three) of cards randomly selected from the print run. Each pack is sealed in a wrapper and sold and distributed to retail outlets such as supermarkets and convenience stores. As a result, when a baseball fan browses through packs of cards available for sale, it is not possible for the fan to identify the cards in a pack without purchasing the pack and opening the wrapper. Fans typically seek to obtain a complete set of cards. This method of selling randomly-generated packs, the contents of which are not visible until after sale, therefore generates additional sales of card packs by fans seeking to obtain complete sets of cards.

Second, the manufacturer may sell and distribute complete sets of cards to collectors and card retailers. Fans typically are willing to pay a premium for a complete set of cards sold in this manner, because of the convenience it provides by avoiding the need for the fan to complete a set by purchasing large numbers of random card packs.

Fans often trade cards with each other in an attempt to obtain complete card sets. The difference in scarcity among different cards often plays out in card trading. For example, a fan with a particularly rare card may be able to obtain several more common cards from another fan in exchange for the rare card. Fans often use trading cards in other ways, such as by using them as the basis for games. Furthermore, although the discussion above refers to baseball cards, trading cards frequently relate to other topics, including not only other sports, but also movies, music, and video games.

### SUMMARY

A computer-implemented method for generating and distributing electronic trading cards, such as for use with mobile devices, generates instances of electronic trading cards and distributes the instances to users over a computer network. The electronic trading card instances may, for example, be transmitted over a wireless network to a mobile computing device. A finite number of instances of each electronic trading card may be generated. Electronic trading card instances may include an image (such as a still image or video stream depicting a baseball player) and a digital watermark. Each of the instances of an electronic trading card may have an identifier that is unique among the instances of that card. One instance of an electronic trading card may include content (such as a fact related to a baseball player) that is not included on all other instances of the same card.

A randomly-generated “pack” of cards may be purchased by and distributed to the user. The contents of the pack may not be made visible to the user until completion of the purchase. Users may purchase different tiers of service, such as a tier of service guaranteeing that the user will not be provided with duplicate instances of any trading card, and a tier of service allowing the user to select instances of specific cards for purchase.

For example, in one aspect of the present invention, a computer-implemented method is provided including: (A) selecting, from a template of an electronic trading card, an image for a first instance of the electronic trading card; (B) selecting a first unique identifier for the first instance of the electronic trading card; and (C) generating the first instance of the electronic trading card, the first instance including a reference to the image and a reference to the first unique identifier.

In another aspect of the present invention, a computer-implemented method is provided including: (A) receiving, over a network, a first instance of an electronic trading card, the first instance including a reference to an image and a reference to a unique identifier for the instance; and (B) displaying a graphical representation of the first instance of the electronic trading card, the graphical representation of the first instance including a graphical representation of the image and a graphical representation of the unique identifier.

In a further aspect of the present invention, a computer-implemented method is provided including: (A) receiving a request from a recipient for a set of electronic trading cards; (B) selecting a first subset of a plurality of electronic trading card templates, wherein at least one of the templates in the first subset is selected using a pseudo-random number generator; (C) generating the requested set by generating a plurality of instances of the first subset of the plurality of electronic trading card templates; and (D) transmitting the plurality of instances over a network to the recipient.

Other features and advantages of various aspects and embodiments of the present invention will become apparent from the following description and from the claims.

### BRIEF DESCRIPTION OF THE DRAWINGS

FIG. 1A is a dataflow diagram of a system for generating and distributing electronic trading cards according to one embodiment of the present invention;

FIG. 1B is a dataflow diagram of a system enabling a user to provide a card server with a selection of one or more electronic trading cards for download and/or purchase;

FIG. 1C is a dataflow diagram of a system for transmitting instances of selected electronic trading cards over a network to a user;

FIG. 1D is a dataflow diagram of a system enabling a user to transmit electronic trading cards over a network to another user;

FIG. 1E is a dataflow diagram of an electronic trading card generation and distribution system in which users may create and maintain accounts with the system;

FIG. 2 is a flowchart of a method that is performed by the system of FIG. 1A according to one embodiment of the present invention;

FIG. 3 is a flowchart of a method performed by the system of FIG. 1E according to one embodiment of the present invention;

FIG. 4A is a diagram of a data structure used to store data for a single electronic trading card template according to one embodiment of the present invention;

FIG. 4B is a diagram of a data structure that is used to store data for a single instance of the card template shown in FIG. 4A;

FIG. 5 is a flowchart of a method for generating a single instance of an electronic trading card for distribution over a network; and

FIGS. 6A-6B are illustrations of graphical representations of electronic trading cards according to one embodiment of the present invention.

### DETAILED DESCRIPTION

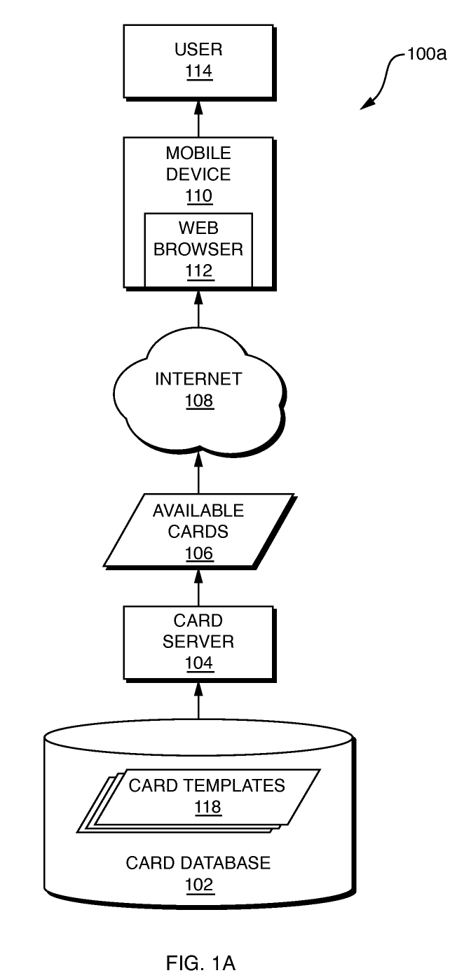

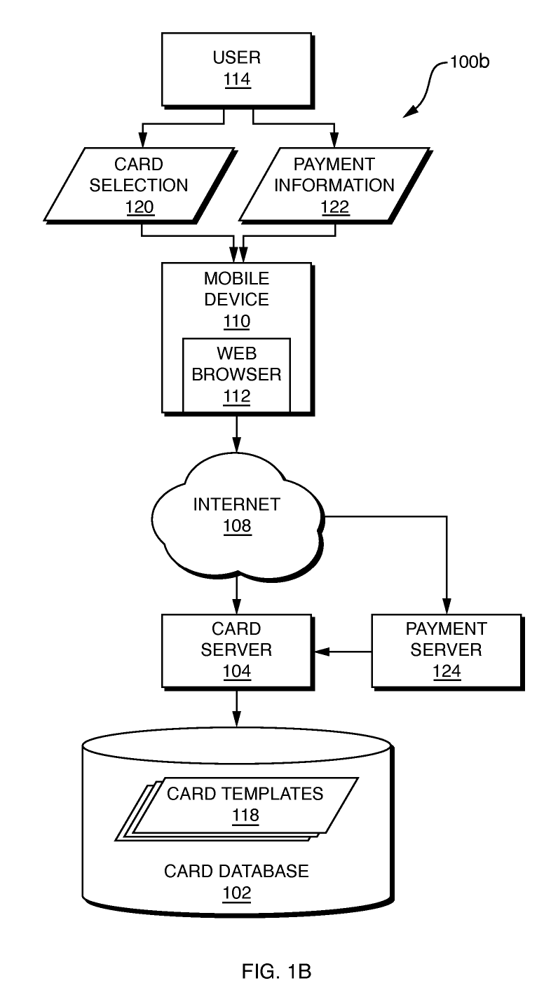

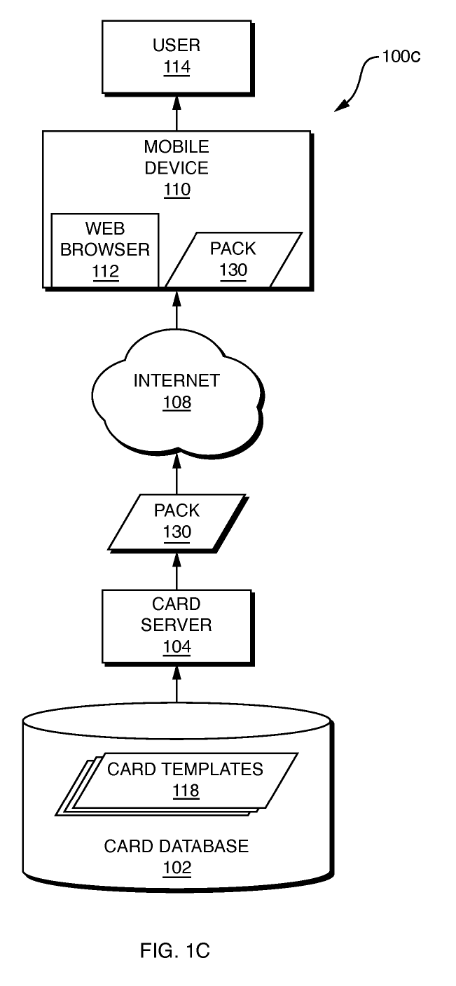

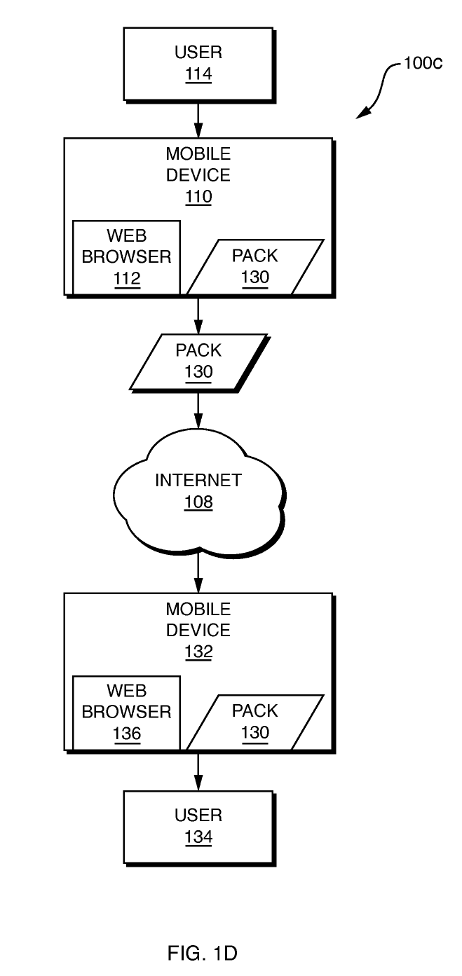

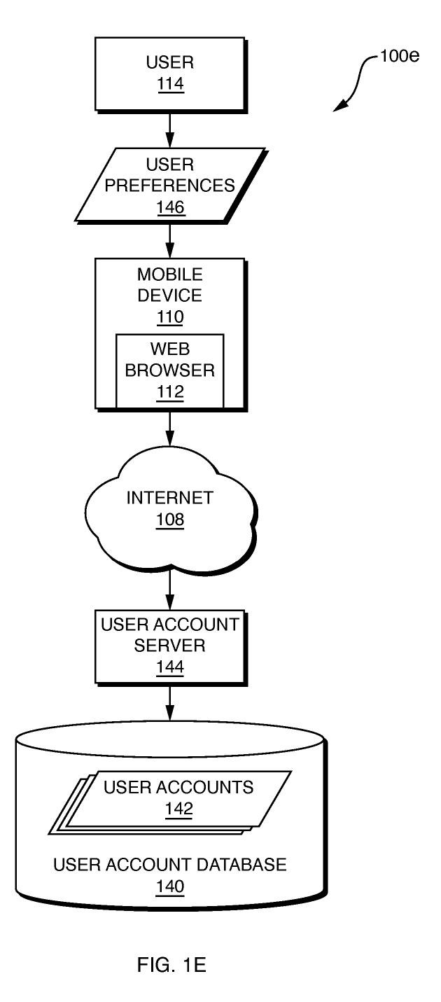

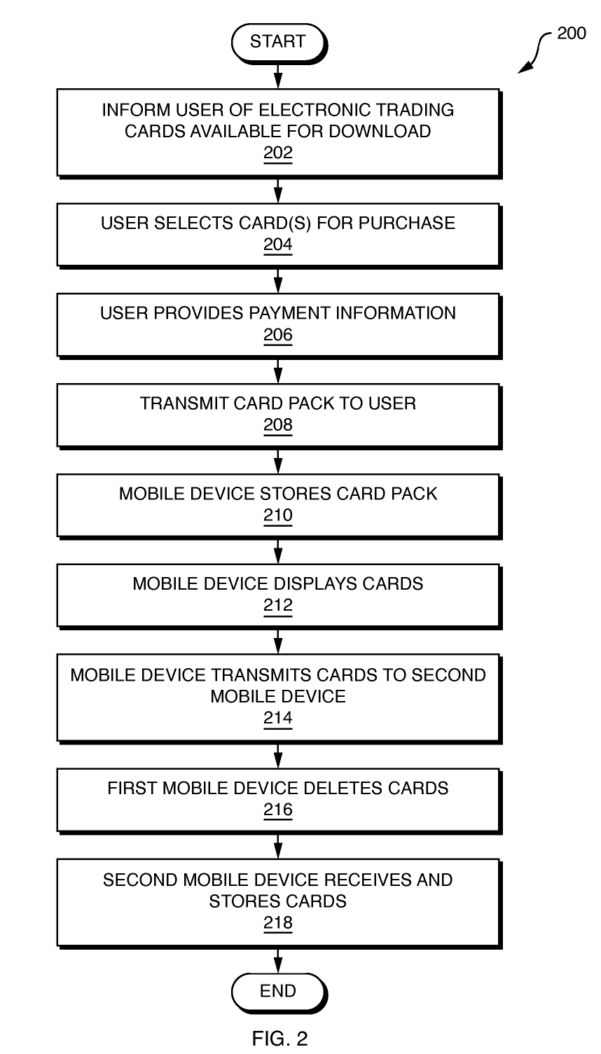

Referring to FIG. 1A, a dataflow diagram is shown of a system 100a for generating and distributing electronic trading cards according to one embodiment of the present invention. Referring to FIG. 2, a flowchart is shown of a method 200 that is performed by the system 100a of FIG. 1A according to one embodiment of the present invention.

The system 100a includes a database 102 of electronic trading cards available for generation and distribution by the system 100a. A card server 104 provides an interface to the card database 102. The card server 104 may be accessible over a network 108, such as the public Internet. For example, the card server 104 (or a separate web server) may host a web site that provides access to the card database 102, as described below. In the following example, the card server 104 hosts an e-commerce website through which instances of cards in the card database 102 may be purchased.

When a user 114 accesses the card server 104, such as by using a web browser 112 on a mobile computing device 110 (e.g., a cell phone or personal digital assistant) to browse to the web site hosted by the card server 104, the card server 104 informs the user 114 of the electronic trading cards which are available for download 106 (FIG. 2, step 202). The available cards 106 may be displayed in any manner. For example, the web site may allow the user 114 to select a category of cards (e.g., baseball, football, basketball), in response to which the card server 104 may display cards in the selected category. The web site may allow the user 114 to search for cards using a text query, e.g., the name of a baseball player or a baseball team. These are merely examples and do not constitute limitations of the present invention.

Note further that the card server 104 may display only limited information about each card to the user 114. For example, the card server 104 may display only the title of the card (such as the name of the baseball player depicted by the card), but not the graphical or textual content of the card. As will be described in more detail below, such additional content may be displayed to the user 114 only after the user 114 has purchased and downloaded the card. Withholding information from the user 114 in this way may encourage the user 114 to purchase the card and thereby increase revenue for the electronic trading card web site.

Furthermore, the card server 104 need not display information about individual cards available for purchase in step 202. Instead, the card server 104 may provide the user 114 with a selection of card “packs” available for purchase. For example, if the user 114 selects the “baseball” card category, the card server 114 may provide the user 114 with the option of purchasing a three-card pack of electronic trading cards for a fixed price (e.g., $1.00). The card server 104 may not display the contents of the pack to the user 114 unless and until the user 114 purchases and downloads the pack. Withholding information about the contents of the pack from the user 114 in this way may encourage the user 114 to purchase the card pack and thereby increase revenue for the electronic trading card web site, in much the same way that hiding the contents of physical trading card packs increases sales of physical trading cards.

The card server 104 may provide the user 114 with a variety of options for purchasing packs of electronic trading cards. For example, the card server 104 may provide packs having different numbers of cards for different prices (e.g., a 3-card pack for $1.00 and a 6-card pack for $1.75), and packs having different categories of cards for different prices (e.g., a generic 3-card pack for $1.00 and an “all-star” 3-card pack for $1.50).

Referring to FIG. 1B, an embodiment of a system 100b is shown in which the user 114 provides the card server 104 with a selection 120 of one or more cards for download and/or purchase (FIG. 2, step 204). The card web site may provide any kind of user interface for enabling the user 114 to select cards. For example, the web site may enable the user 114 to select one or more kinds and quantities of card packs and add them to a conventional web-based shopping cart.

If the selected card(s) is/are to be purchased, rather than downloaded without charge, the user 114 provides payment information 122 (FIG. 2, step 206). In the example shown in FIG. 1B, a separate payment server 124 receives and validates the payment information 122. If the payment server 124 successfully validates the payment information 122, the payment server 124 informs the card server 104 that the user 114 is authorized to make the necessary payment. Alternatively, for example, if the mobile device 110 is a mobile telephone, fees for the electronic trading card system 100a may be added to the user's mobile telephone bill.

Referring to FIG. 1C, an embodiment of a system 100c is shown in which the card server 104 transmits instances of the selected cards, in the form of a card pack 130, over the network 108 to the user's mobile device 110 (FIG. 2, step 208). Note that the term card “pack” in this context refers to instances of one or more cards generated, selected, and transmitted in any manner.

The mobile computing device 110 stores the card pack 130 (FIG. 2, step 210), such as on a hard disk drive. The user 114 may then use the mobile device 110 to display any one or more of the cards in the pack 130 on a display screen of the mobile device 110 (step 212). The cards in the pack 130 may be displayed for example, using the mobile device web browser 112, using an MMS client on the mobile device 110, or using a media viewer on the mobile device 110.

Referring to FIG. 1D, an embodiment of a system 100d is shown in which the user 114 transmits the pack 130 to the mobile device 132 of another user 134 (FIG. 2, step 214). Upon transmitting the pack 130, the first mobile device 110 may delete the card pack 130 (or the subset of the card pack 130 transmitted to the second mobile device 132) (FIG. 2, step 216). Note, however, that deletion of the card pack 130 from the first mobile device 110 is optional. The second mobile device 132 receives the card pack 130 (or any subset of the card pack 130 received by the second mobile device 132) and stores it, such as on a hard disk drive (FIG. 2, step 218). The second user 134 may use, for example, a web browser 136, MMS client, or media viewer on the second mobile device 132 to display the contents of the pack on a display screen of the second mobile device 132.

Cards may incorporate digital rights management (DRM) mechanisms. DRM in a card may be used, for example, to enforce a policy of deleting the card from the mobile device 132 when the card is transmitted from the mobile device 132. DRM may be used to perform other functions, such as prohibiting duplication of card instances.

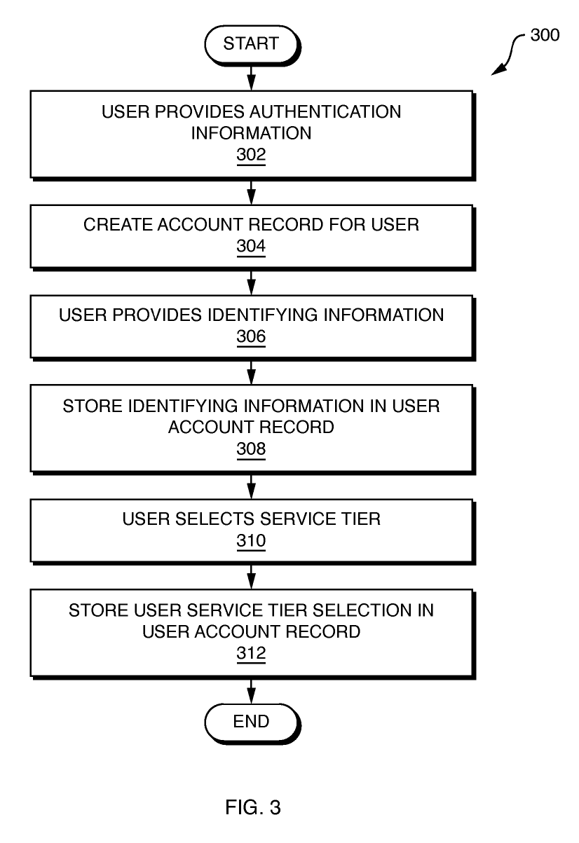

Referring to FIG. 1E, an embodiment of an electronic trading card generation and distribution system 100e is shown in which users may create and maintain accounts with the system 100e. Referring to FIG. 3, a flowchart is shown of a method 300 that is performed by the system 100e of FIG. 1E according to one embodiment of the present invention.

The user 114 may begin, for example, by accessing the same electronic card trading e-commerce web site as described above. This web site may both allow the user 114 to manage account information and to download/purchase instances of electronic trading cards. Therefore, although a distinct user account server 144 is shown in FIG. 1E for purposes of example, it should be appreciated that any combination of servers may be used to perform the various functions illustrated in FIGS. 1A-1E.

The user account server 144 maintains a database 140 of user account information 142. The user account information 142 includes account information for each user who has registered with the system 100e. The user 114 may, for example, access the e-commerce web site described above and create an account by providing authentication information, such as a username and password (FIG. 3, step 302). In response, the user account server 144 may create a record for the user 114 in the user information 142 in the account database 140 (step 304).

The authentication information is one example of what is illustrated in FIG. 1E as user preferences 146. More generally, the user preferences 146 represents any information provided by the user 114 for use in creating and/or modifying the user's account record. For example, the user 114 may provide additional identifying information, such as the user's full name, mailing address, and email address, to the account server 144 (step 306) for storage in the user account database 140 (step 308).

The user 114 may also select a tier of service (step 310). For example, in one embodiment the system 100e offers three tiers of service: (1) a first tier of service having terms allowing duplicate instances of electronic trading cards to be transmitted to the user 114; (2) a second tier of service having terms not allowing duplicate instances of electronic trading cards to be transmitted to the user 114; and (3) a third tier of service having terms allowing the user 114 to specify a particular one of a plurality of electronic trading cards for transmission to the user.

Furthermore, different tiers of service may be offered at different prices. For example, the first tier of service just described, in which the user 114 is only allowed to purchase randomly-generated packs of cards, and in which the user 114 may thereby receive more than one instance of the same trading card, may be offered for a first, relatively low price. This tier is an example of a “basic” tier of service.

The second tier of service just described, in which the user 114 is provided with a guarantee that the system will not distribute to the user 114 more than one instance of the same electronic trading card, may be offered for a second price that is higher than the price of the first tier of service. This tier is an example of a “premium” tier of service. As described in more detail in the above-referenced patent application, the card server 104 (or other mechanism) may allow the user 114 to maintain a “checklist” of cards received by the user 114, whether the user 114 received such cards from the card server 104 or from another user. To add a card to the checklist, the user 114 may transmit the card to the card server 104. As a result, the second tier of service may guarantee that the card server 104 will not provide the user 114 with a duplicate of a card that is on the user's checklist. The user 114, therefore, may receive protection not only against receiving duplicates of cards the user 114 received from the card server 104, but also against receiving duplicates of cards the user 114 received from other users.

The third tier of service just described, in which the user 114 is allowed to select specific trading cards for purchase (i.e., trading cards of baseball players specified by the user), may be offered for a third price that is higher than the price of the second tier of service. This tier is an example of an “ultra-premium” tier of service.

Storing such user preferences in the user account database 140 enables the systems 100a-e depicted in FIGS. 1A-1E to interact with the user 114 in accordance with the user's preferences. For example, storing the user's selected tier of service in the user's account record in the user account database 140 enables the system 100a shown in FIG. 1A to display the available selection of cards to the user 114 in accordance with the user's preferences. For example, if the user 114 has subscribed to the “basic” tier of service, the card server 104 may only display to the user 114 a selection of card packs for purchase, the contents of which are hidden from the user 114 until the purchase is complete. If, however, the user 114 has subscribed to the “ultra-premium” tier of service, the card server 104 may display to the user 114 descriptions and images of individual cards available for purchase.

Similarly, storing the user's selected tier of service in the user's account record in the user account database 140 enables the system 100c shown in FIG. 1C to generate the card pack 130 in accordance with the user's preferences. If, for example, the user 114 has subscribed to the “basic” tier of service, the card server 104 may generate the contents of the pack 130 randomly, without regard to the cards previously transmitted to the user 114. If, however, the user 114 has subscribed to the premium (i.e., “no duplicates”) tier of service, the card server 104 may ensure that the pack 130 does not include any duplicate instances of the same card, and that the pack 130 does not include instances of any cards previously transmitted to the user 114. This function may be performed by storing, in the user's account record in the account database 140, a record of cards previously transmitted to the user 114, and by appropriate communication between the card server 104 and the user account server 144.

Having generally described various embodiments of the present invention, particular embodiments of the present invention will now be described in more detail.

In the embodiment illustrated in FIG. 1A, the card database 102 includes a plurality of card templates 118. Each of the card templates 118 represents a distinct electronic trading card. For example, assume that the card templates 118 collectively represent a complete set of baseball for a single season, analogously to a complete set of physical baseball cards printed by a traditional baseball card manufacturer. In such an example, one of the card templates 118 may represent an electronic trading card for one baseball player, while another one of the card templates may represent an electronic trading card for another baseball player.

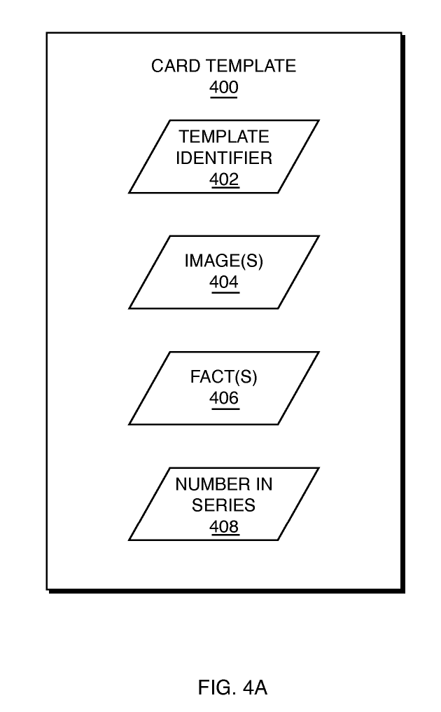

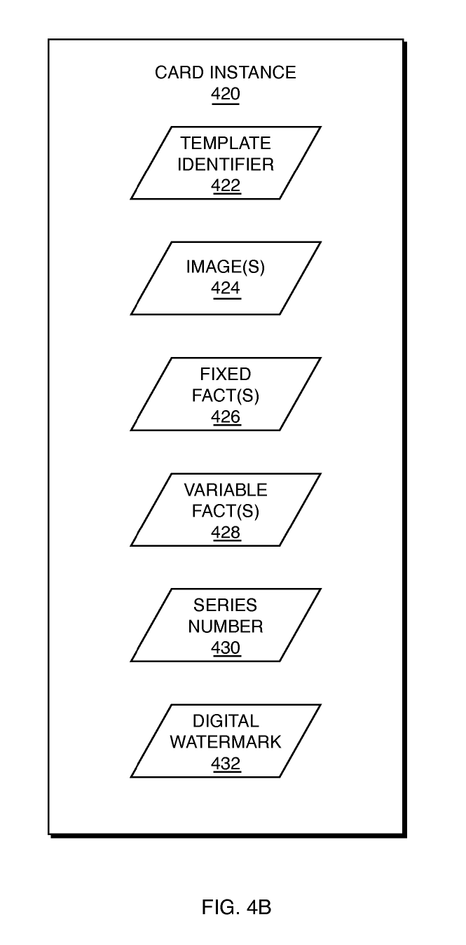

Referring to FIG. 4A, a diagram is shown illustrating a data structure 400 that is used to store the data for a single one of the card templates 118 according to one embodiment of the present invention. The data structure 400 may, for example, store data for the electronic trading card for a single basketball player, such as Lebron James.

In the embodiment illustrated in FIG. 4A, the template 400 includes a template ID 202, which uniquely identifies the template 400 among the templates 118 in the card database 102. The template 400 also includes an image 404. The image 404 may, for example, be a digital still image of the corresponding basketball player (e.g., Lebron James). For example, in one embodiment, the image is a 640×480 pixel, 24-bit JPEG image, with a file size of less than 100 KB.

As yet another example, the player image 404 may be a video clip of the corresponding baseball player. Such a video clip may, for example, be a 96 kbps, 15 FPS, resolution SQCIF/QCIF, audio MPEG 4 Simple Profile 0,1, with a file extension of 0.3gp or .mov, clip length <15 sec, and file size of <200 KB. As yet another example, the player image 404 may include multiple still images and/or video clips of or related to the corresponding baseball player.

The template 400 also includes a set of facts 406 related to the subject matter of the template 400. For example, the facts 406 may include the corresponding baseball player's name, age, weight, team, and statistics from the previous season.

The template 400 also includes a maximum count 408 of the number of instances of the template 400 that the system 100a may generate. The value of the maximum count may, for example, be set by the vendor of the electronic baseball card templates 118. The maximum count 408 may vary from template to template. For example, the vendor may choose to set the maximum count 408 to a relatively low number if the subject matter of the template 400 (e.g., the baseball player represented by the template 400) is in high demand (e.g., if the baseball player is popular or an all-star), while the vendor may choose to set the maximum count 408 to a relatively high number if the subject matter of the template 400 is in relatively low demand. In this way, additional scarcity may be created.

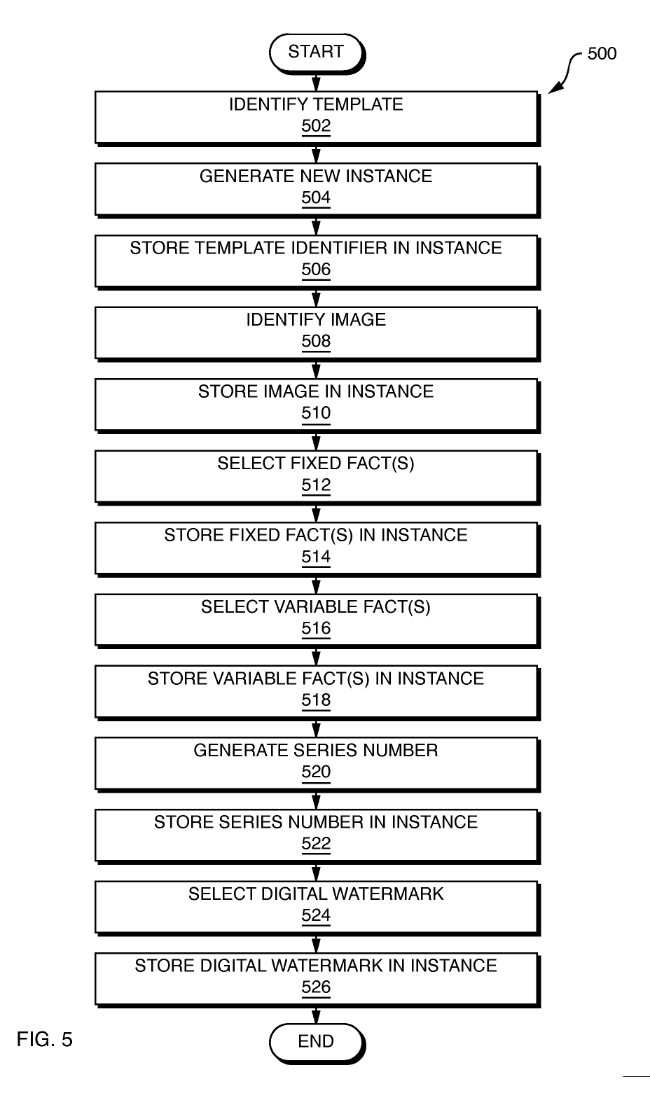

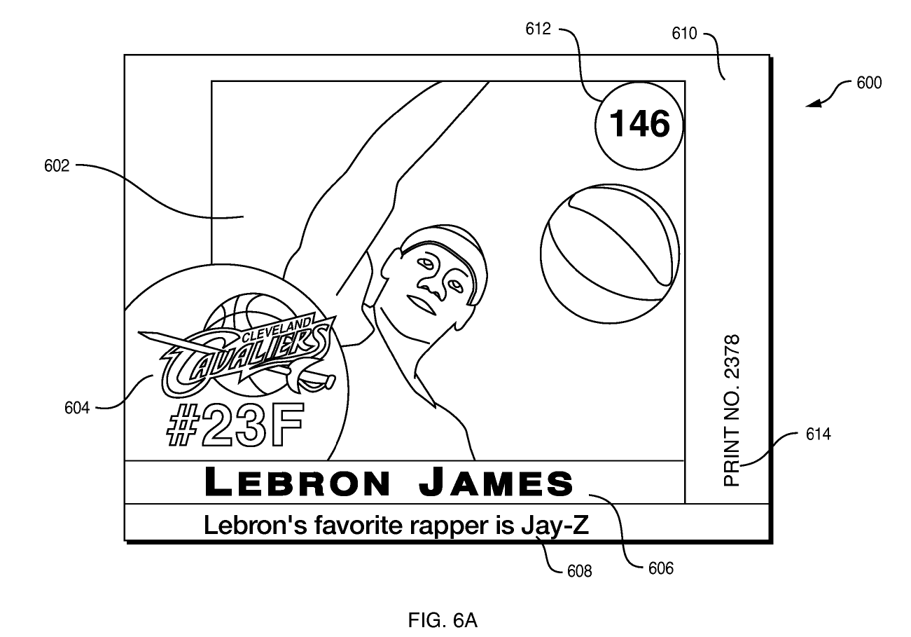

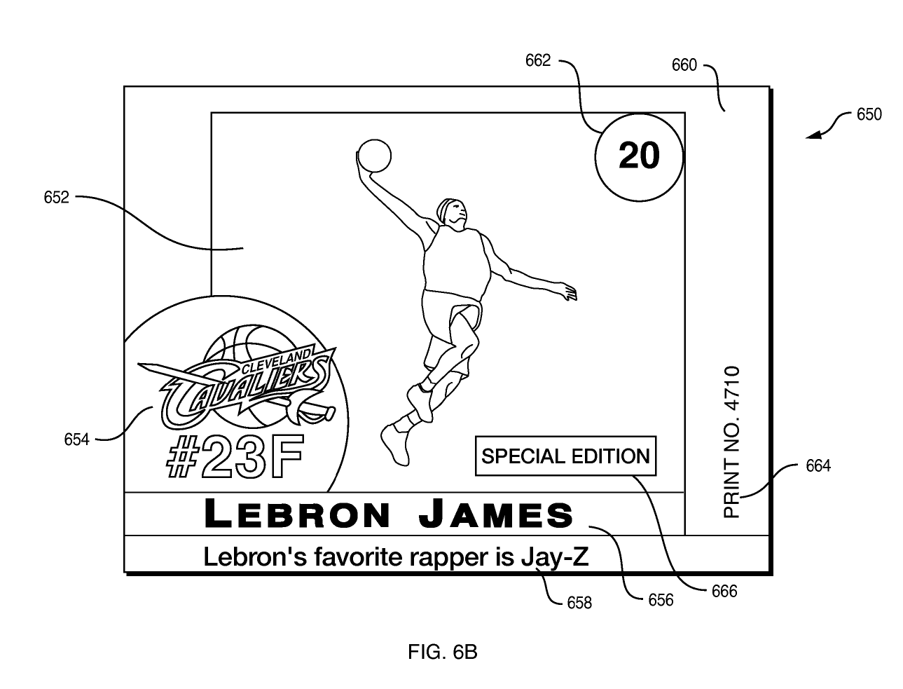

The data structure 400 shown in FIG. 4A is referred to as a “template” because it is used to generate particular “instances” of the trading card represented by the template. For example, consider again the pack generation and distribution illustrated in FIG. 1C. It was stated above that the card server 104 may randomly select card instances for inclusion in the pack 130. Referring to FIG. 5, a flowchart is shown of a method 500 for generating a single instance of an electronic trading card for distribution to the user 114. Techniques that may be used to generate a pack of cards will be described below with respect to FIG. 6.

Referring to FIG. 4B, a diagram is shown illustrating a data structure 420 that is used to store the data for a single instance of the card template 400 illustrated in FIG. 4A. The data structure 420 may, for example, store data for a single instance of a Lebron James card. The template 400 shown in FIG. 4A and the instance 420 shown in FIG. 4B will be used to illustrate operation of the method 500 shown in FIG. 5.

Referring to FIG. 6A, an illustration is shown of a rendering of an instance of an electronic trading card 600, as it may appear on the display screen of a mobile computing device. In the example shown in FIG. 6A, the card is a standard card for basketball player Lebron James. Referring to FIG. 6B, an illustration is shown of a rendering of an instance of another electronic trading card 650, as it may appear on the display screen of a mobile computing device. In the example shown in FIG. 5B, the card is a “special edition” card for Lebron James.

Returning to FIG. 5, the card server 104 generates a new electronic trading card instance (step 502). The electronic trading card instance (such as the instance 420 shown in FIG. 4B) begins without any data.

The card server 104 then identifies a template (within the set of templates 118 in the card database 102) for use in generating an instance of an electronic trading card (FIG. 5, step 502). If, for example the card server 104 is in the process of randomly selecting cards for inclusion in the pack 130, then the card server 104 may identify a template using a pseudo-random number generator. As another example, if the user 114 has subscribed to the ultra-premium tier of service, the user 114 may indicate (using an appropriate user interface) a selection of a particular card template. Assume for purposes of example that the card server 104 identifies the template of the standard Lebron James card, an instance of which is illustrated in FIG. 6A.

Once the card template has been identified, the card server 104 stores the template ID (e.g., template ID 402 in FIG. 4A) in the new card instance (e.g., as template ID 422). This identifies, for example, the instance 422 as an instance of the corresponding template (e.g., template 400). For example, all instances of Lebron James cards share the same template ID, thereby identifying them as Lebron James cards. The card numbers 612 and 662 in FIGS. 6A and 6B are examples of how template IDs may be reflected in graphical representations of electronic trading card instances.

The card server 104 selects an image from the template for inclusion in the card instance (step 508). In the embodiment illustrated in FIG. 4B, the card server 104 has copied the image 404 from the template 400 (FIG. 4A) into the player image 424 in the card instance 420 (FIG. 4B). In FIG. 6A, the player image 602 is an example of player image 424. Similarly, in FIG. 6B, the player image 652 is an example of player image 424.

In the example of FIG. 5, therefore, all instances of the same template share the same image. This is not, however, a requirement of the present invention. For example, different instances of the same card may include different images of the same player. As another example, some instances of a card may include still images of a player, while other (higher-priced) images of the same card may include video streams of the same player. A single card may include multiple images, which may or may not be displayed simultaneously when the card instance is displayed by the mobile device 110.

The card server 104 selects one or more fixed facts for inclusion in the card instance (step 512). For example, certain ones of the facts 406 in the template 400 (such as the baseball player's name and team) may be designed as fixed facts that are to be included in all instances of the template 400. Such fixed facts may be stored as fixed facts 426 in the card instance 420 (FIG. 5, step 514). The team logos 604 and 654, and the player names 606 and 656 in FIGS. 6A and 6B illustrate how fixed facts may be displayed in electronic trading card instances.

Certain ones of the facts 406 may be designated as variable facts, i.e., facts that may be included in some instances of the template 400 but not others. The card server 104 may select one or more variable facts for inclusion in the card instance (step 516). Such fixed facts may be stored as variable facts 428 in the card instance 420 (FIG. 5, step 518). Although any fact may be designated as either fixed or variable, one example of a variable fact is a description of a highlight of the career of the player represented by the card instance 420. The facts 608 and 658 in FIGS. 6A and 6B illustrate how variable facts may be displayed in electronic trading card instances.

As mentioned above, the system 100c may enforce the generation of a limited number of instances of each of the card templates 118. Recall that the maximum count 408 in the template 400 may specify the maximum permissible number of instances of the template 400. The card server 104 may maintain a running count of the number of instances generated so far of each of the templates 118. Returning to FIG. 5, the card server 104 may increment the running count of instances of the template 400 generated so far 400, and store the current count as a series number 430 in the card instance 420. The card server 104 may also store the value of the maximum count 408 in the card instance 420, although this is not shown in the example of FIG. 4B. The print numbers 614 and 664 in FIGS. 6A and 6B illustrate how series numbers may be displayed in electronic trading card instances.

The card server 104 may also select (step 524) a digital watermark 432 and store the digital watermark 432 in the card instance 420 (step 526). Any of a variety of well-known techniques may be used to generate and store the digital watermark 432. The digital watermark 432 may, for example, be integrated with the image 424. Note that the image 424 in the card instance 420 may be a composite of multiple images. For example, the image 424 may be a composite of an image of a baseball player, an image of the baseball player's team logo, and a border. For example, the electronic trading card instances 600 and 650 shown in FIGS. 6A and 6B include composite images including player images 602 and 652, team logos 604 and 654, player names 606 and 656, variable facts 608 and 658, borders 610 and 660, card (template) numbers 612 and 662, series (print) numbers 614 and 664. There may be (in the case of special edition card 650) a special card indication 666. The digital watermark 432 may be integrated with such a composite image.

The digital watermark 432 may be unique to the card instance 420, thereby subsequently enabling the card instance 420 to be identified uniquely among all card instances generated and distributed by the card server 104. Individual card instances may, however, be identified in other ways after they have been generated and transmitted by the card server 104. For example, image recognition software may be applied to the image(s) 424 to identify, for example, the player and/or team represented by a card instance. Similarly, image recognition software may be applied to a graphical representation of the series number 430 to identify the series number 430. Various combinations of these techniques may be applied to identify a particular card instance.

Once the instance 420 has been generated, it may be transmitted to the user's mobile device 110 in the manner described above. The instance may, for example, be transmitted as a graphic image in Multi-media Message Service (MMS) or WAP format. The pack 130 of cards may, for example, be transmitted as a single message or as a sequence of messages, each containing an individual card instance. If the pack 130 is transmitted as a sequence of messages, each message may, for example, include an identifier of the pack 130 (e.g., a pack number) in the message subject line or other message header.

As made clear by the preceding discussion, the techniques just described enable each instance of an electronic trading card to be unique, even when multiple instances represent the same electronic trading card. For example, the series number 430 of the electronic trading card instance distinguishes the instance 420 from all other instances of the same template 400. Furthermore, the digital watermark 432 may also distinguish the instance 420 from all other instances of the same template 400.

The techniques disclosed herein may be used to effectively replicate the visual appeal, market dynamics and viral nature of a traditional card trading paradigm. The electronic trading card generation and distribution techniques disclosed herein may spur the development of a new content category on the mobile phone-card trading and, more generally, digital media trading. Card trading appeals to sports fans, as well as music, movies, gaming, shopping and collecting enthusiasts. The development of mobile trading cards enables companies to create viral marketing campaigns around both new and existing content in a simple and intuitive way.

The generation and distribution of limited numbers of unique electronic trading cards creates a kind of scarcity in digital content that is analogous to the scarcity that has long existed in printed trading cards. The techniques disclosed herein, like in their printed analogs, may be used to create sets containing a finite number of cards, and to create a finite number of instances (copies) of each card in a set. Such scarcity drives demand. Digital technology, however, enables even instances of the same card to vary from each other, such as through the use of the variable facts discussed herein. Such techniques create a degree of scarcity not before possible, thereby enabling further demand to be created for electronic trading cards.

Furthermore, the unique nature of each card instance enables each card instance to be tracked to the user to whom it was originally transmitted. This tracking feature may, for example, be used to flag potential “super users” or “web posters,” as well as to learn more about “trading” communities.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions. For example, the card server 104, user account server 144, and payment server 124 may be combined into fewer components or separated into a greater number of components for performing the same functions.

Also certain examples described herein refer to electronic trading cards representing baseball card players, this is not a limitation of the present invention. Rather, the techniques disclosed herein may be applied to electronic trading cards representing any subject matter, such as any sport, entertainment (e.g., movies, television or music), and cultural genres.

Electronic trading cards implemented in accordance with the techniques disclosed herein may include any kind of data. For example, in one embodiment, an electronic trading card includes the following data: an image, card number (e.g., template ID), name (e.g., player, actor, musician), sub-title (e.g., position, episode name, album), team logo (if applicable), set sponsor logo (e.g., NBA, Fox), variable fact, and series number.

Furthermore, the techniques disclosed herein may be applied to digital content other than electronic trading cards. For example, techniques disclosed herein may be applied to digital content such as ringtones.

Content, such as the image(s) 404 and fact(s) 406 need not be pre-specified by the operator of the card server 104. For example, the card server 104 may allow users to create and/or edit content in card templates. For example, the card server 104 may provide a mechanism whereby a user can create a new card template, such as a template for a trading card depicting an image of the user and facts about the user. Such a mechanism may allow the user to upload content (such as the image of the user and facts about the user) for storage in the new template in the card database 102. Subsequently, the card server 104 may use such a user-designed template to generate and distribute card instances in the manner described above. Similarly, the card server 104 may allow the user to edit existing (system-defined and/or user-defined) card templates.

Electronic trading cards implemented in accordance with the techniques disclosed herein may be rendered in any manner. For example, such cards may be rendered to produce still graphic images, video streams, audio streams, or any combination thereof. A card may be rendered to include a “front” side (e.g., containing an image of a baseball player) and a “back” side (e.g., containing statistics related to the player). The card may be rendered to include hyperlinks, which the user may follow to other content within the card or external to the card.

Each card instance's series number (or other unique identifier) may be displayed when the card instance is rendered. For example, if a card instance has series number 237 out of a total of 10,000 instances of that card, the text “237/10000” may be displayed in the rendering of the card, like a edition bottle of wine (e.g. No. 2485 of 18655).

Any number of templates may be used to generate card instances within a set of cards. For example, there may be a single template for an entire set. Alternatively, for example, there by be multiple templates for an entire set. Furthermore, even a single electronic trading card (such as a Lebron James trading card) may be generated using multiple templates, or using different templates at different times. For example, the content of a template for a Lebron James card may change during the course of a baseball season. As a result, different Lebron James card instances may be generated using different templates.

If the user 114 subscribes to the electronic trading card system, the system may periodically send packs to the user 114 automatically. For example, the system may automatically send a pack containing, for example, three cards to the user 114 once every two weeks. The user 114 may opt to receive packs more or less frequently. The user 114 may purchase packs manually. The system may impose a limit, however, on the number of packs the user 114 may purchase in a particular period of time. For example, the system may limit the user 114 to purchasing eight packs per month.

The term “mobile computing device” as used herein includes, but is not limited to, cellular telephones, personal digital assistants, handheld computers, iPods and other digital media players, and any combination thereof. Furthermore, although certain examples described herein refer to mobile computing devices, the techniques disclosed herein are not limited to use with mobile computing devices. Rather, the techniques disclosed herein may be applied to other computing devices, such as desktop and laptop computers.

Although certain examples described herein refer to the use of a web browser to access electronic trading cards, this is not a limitation of the present invention. For example, software other than a web browser may be used to access electronic trading cards using protocols other than TCP/IP and HTTP over any kind of network. For example, the techniques disclosed herein may be implemented using proprietary software and/or network protocols, such as those employed by Apple Computer's iTunes software.

Although certain examples described herein refer to “storing” data in instances of electronic trading cards, such data need not be contained within the instance itself. For example, an image may be “stored” within an instance of an electronic trading card by storing a reference (e.g., a hyperlink) to the image within the instance of the electronic trading card. Similarly, data may be “stored” within an instance of an electronic trading card by storing a computer program in the electronic trading card that is capable of generating the data when executed.

The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. A computer-implemented method comprising:
(A) selecting, from a template of an electronic trading card, an image for a first instance of the electronic trading card;
(B) selecting a first unique identifier for the first instance of the electronic trading card; and
(C) generating the first instance of the electronic trading card, the first instance including a reference to the image and a reference to the first unique identifier.

2. The method of claim 1, wherein the first instance includes the image.

3. The method of claim 1, wherein the first instance includes the first unique identifier.

4. The method of claim 1, wherein (A) comprises selecting a video stream from the template, the video stream including the selected image.

5. The method of claim 1, wherein (B) comprises selecting the first unique identifier from a finite set of unique identifiers available for instances of the template.

6. The method of claim 5, wherein the template defines a maximum instance count, and wherein (B) comprises selecting a unique identifier representing a counter having a value less than the maximum instance count.

7. The method of claim 5, further comprising:
(D) selecting a digital watermark for the first instance of the electronic trading card; and
wherein (C) comprises generating the first instance of the electronic trading card, the first instance including the image, the first unique identifier, and the digital watermark.

8. The method of claim 7, wherein the image includes the digital watermark.

9. The method of claim 1, further comprising:
(D) selecting a content unit, from among a finite set of content units available for instances of the template, for the first instance of the template; and
wherein (C) comprises generating the first instance of the electronic trading card, the first instance including the image, the first unique identifier, and the selected content unit.

10. The method of claim 1, wherein the image represents particular subject matter, and wherein the content unit represents information descriptive of the particular subject matter.

11. The method of claim 1, wherein the image represents a person, and wherein the content unit represents a fact descriptive of the person.

12. The method of claim 1, further comprising:
(D) transmitting the first instance of the electronic trading card over a network to a recipient.

13. The method of claim 12, wherein (D) comprises transmitting the instance of the electronic trading card over the network to a mobile computing device.

14. The method of claim 1, further comprising:
(D) selecting a second unique identifier for a second instance of the electronic trading card; and
(E) generating a second instance of the electronic trading card, the second instance including a reference to the image and a reference to the second unique identifier.

15. An apparatus comprising:
image selection means for selecting, from a template of an electronic trading card, an image for a first instance of the electronic trading card;
unique ID selection means for selecting a first unique identifier for the first instance of the electronic trading card; and
card instance generation means for generating the first instance of the electronic trading card, the first instance including a reference to the image and a reference to the first unique identifier.

16. The apparatus of claim 15, wherein the image selection means comprises means for selecting a video stream from the template, the video stream including the selected image.

17. The apparatus of claim 15, wherein the unique ID selection means comprises means for selecting the first unique identifier from a finite set of unique identifiers available for instances of the template.

18. The apparatus of claim 15, further comprising:
digital watermark selection means for selecting a digital watermark for the first instance of the electronic trading card; and
wherein the card instance generation means comprises generating the first instance of the electronic trading card, the first instance including the image, the first unique identifier, and the digital watermark.

19. The apparatus of claim 15, further comprising:
content unit selection means for selecting a content unit, from among a finite set of content units available for instances of the template, for the first instance of the template; and
wherein the card instance generation means comprises means for generating the first instance of the electronic trading card, the first instance including the image, the first unique identifier, and the selected content unit.

20. A computer-implemented method comprising:
(A) receiving, over a network, a first instance of an electronic trading card, the first instance including a reference to an image and a reference to a unique identifier for the instance;
(B) displaying a graphical representation of the first instance of the electronic trading card, the graphical representation of the first instance including a graphical representation of the image and a graphical representation of the unique identifier.

21. The method of claim 20, wherein the first instance includes the image.

22. The method of claim 20, wherein the first instance includes the first unique identifier.

23. The method of claim 20, wherein the first instance includes a reference to a video stream, the video stream including the image.

24. The method of claim 20, wherein the unique identifier represents a series number of the first instance, and wherein the graphical representation further includes a graphical representation of a maximum number of instances of the electronic trading card.

25. The method of claim 20, wherein the first instance further includes a reference to a digital watermark, and wherein (B) comprises displaying the graphical representation in conjunction with a graphical representation of the digital watermark.

26. The method of claim 25, wherein the image includes the digital watermark.

27. The method of claim 20, wherein the first instance further includes a reference to a content unit, selected from among a finite set of content units available for instances of the electronic trading card; and
wherein the graphical representation of the first instance further comprises a graphical representation of the content unit.

28. The method of claim 20, wherein the image represents particular subject matter, and wherein the content unit represents information descriptive of the particular subject matter.

29. The method of claim 20, wherein the image represents a person, and wherein the content unit represents a fact descriptive of the person.

30. An apparatus comprising:
content reception means for receiving, over a network, a first instance of an electronic trading card, the first instance including a reference to an image and a reference to a unique identifier for the instance;
display means for displaying a graphical representation of the first instance of the electronic trading card, the graphical representation of the first instance including a graphical representation of the image and a graphical representation of the unique identifier.

31. The apparatus of claim 30, wherein the first instance includes a reference to a video stream, the video stream including the image.

32. The apparatus of claim 30, wherein the unique identifier represents a series number of the first instance, and wherein the graphical representation further includes a graphical representation of a maximum number of instances of the electronic trading card.

33. The apparatus of claim 30, wherein the first instance further includes a reference to a digital watermark, and wherein the display means comprises means for displaying the graphical representation in conjunction with a graphical representation of the digital watermark.

34. The apparatus of claim 30, wherein the first instance further includes a reference to a content unit, selected from among a finite set of content units available for instances of the electronic trading card; and
wherein the graphical representation of the first instance further comprises a graphical representation of the content unit.

35. A computer-implemented method comprising:
(A) receiving a request from a recipient for a set of electronic trading cards;
(B) selecting a first subset of a plurality of electronic trading card templates, wherein at least one of the templates in the first subset is selected using a pseudo-random number generator;
(C) generating the requested set by generating a plurality of instances of the first subset of the plurality of electronic trading card templates; and
(D) transmitting the plurality of instances over a network to the recipient.

36. The method of claim 35, wherein the request does not specify the first subset of the plurality of electronic trading card templates.

37. The method of claim 35, wherein (C) comprises generating an instance of each template in the selected subset of the plurality of electronic trading card templates and, for each of the plurality of instances, selecting an identifier for the instance that is unique among instances of the corresponding template.

38. The method of claim 35, further comprising:
(E) before (D), receiving payment from a user; and
(F) performing (B)-(D) in response to (E).

39. The method of claim 35, wherein no two of the templates in the first subset are the same template.

40. The method of claim 39, wherein (B) comprises identifying a second subset of the plurality of electronic trading card templates previously transmitted to the recipient, and wherein the first subset does not include any templates in the second subset.

41. The method of claim 35, wherein the request specifies at least one of the first subset of the plurality of electronic trading card templates.

42. The method of claim 35, wherein the recipient comprises a mobile computing device.

43. An apparatus comprising:
request reception means for receiving a request from a recipient for a set of electronic trading cards;
selection means for selecting a first subset of a plurality of electronic trading card templates, wherein at least one of the templates in the first subset is selected using a pseudo-random number generator;
generation means for generating the requested set by generating a plurality of instances of the first subset of the plurality of electronic trading card templates; and
transmission means for transmitting the plurality of instances over a network to the recipient.

44. The apparatus of claim 43, wherein the request does not specify the first subset of the plurality of electronic trading card templates.

45. The apparatus of claim 43, wherein the generation means comprises means for generating an instance of each template in the selected subset of the plurality of electronic trading card templates and, for each of the plurality of instances, selecting an identifier for the instance that is unique among instances of the corresponding template.

46. The apparatus of claim 43, wherein no two of the templates in the first subset are the same template.

47. A computer-implemented method comprising:
(A) receiving payment from a user for a selected tier of electronic trading card subscription service, wherein the selected tier of service has terms and is one of:
(1) a first tier of service having terms allowing duplicate instances of electronic trading cards to be transmitted to the user; and
(2) a second tier of service having terms not allowing duplicate instances of electronic trading cards to be transmitted to the user;
(B) receiving a request from the user for an instance of an electronic trading card;
(C) in response to the request, generating an instance of the electronic trading card in accordance with the terms of the selected tier of service; and
(D) transmitting the generated instance of the electronic trading card to the user over a network.

48. The method of claim 47, wherein (D) comprises transmitting the generated instance of the electronic trading card to a mobile computing device over the network.

49. The method of claim 47, wherein the selected tier of service is one of:
(1) a first tier of service having terms allowing duplicate instances of electronic trading cards to be transmitted to the user;
(2) a second tier of service having terms not allowing duplicate instances of electronic trading cards to be transmitted to the user; and
(3) a third tier of service having terms allowing the user to specify a particular one of a plurality of electronic trading cards for transmission to the user.

50. The method of claim 47, wherein the generated instance of the electronic trading card includes an identifier for the instance that is unique among instances of the electronic trading card.

51. An apparatus comprising:
payment reception means for receiving payment from a user for a selected tier of electronic trading card subscription service, wherein the selected tier of service has terms and is one of:
(1) a first tier of service having terms allowing duplicate instances of electronic trading cards to be transmitted to the user; and
(2) a second tier of service having terms not allowing duplicate instances of electronic trading cards to be transmitted to the user;
request reception means for receiving a request from the user for an instance of an electronic trading card;
generation means for generating, in response to the request, an instance of the electronic trading card in accordance with the terms of the selected tier of service; and
transmission means for transmitting the generated instance of the electronic trading card to the user over a network.

52. The apparatus of claim 51, wherein the selected tier of service is one of:
(1) a first tier of service having terms allowing duplicate instances of electronic trading cards to be transmitted to the user;
(2) a second tier of service having terms not allowing duplicate instances of electronic trading cards to be transmitted to the user; and
(3) a third tier of service having terms allowing the user to specify a particular one of a plurality of electronic trading cards for transmission to the user.
